(19) United States
(12) Patent Application Publication
(10) Pub. No.: US 2025/0296212 A1
(43) Pub. Date: Sep. 25, 2025

(54) INSTALLATION TOOL, USE THEREOF, AND METHOD FOR SECURING A THREADED INSERT

(71) Applicants: Dieter JÜLING, Kelkheim (DE); HOWMET AEROSPACE INC., Pittsburgh, PA (US)

(72) Inventors: Dieter JÜLING, Kelkheim (DE); Nikolas RASCHKE, Wiesbaden (DE)

(21) Appl. No.: 18/861,753

(22) PCT Filed: Jul. 26, 2022
(86) PCT No.: PCT/DE2022/100539

§ 371 Date: Oct. 30, 2024

(51) Int. Cl. B25B 27/14

(52) U.S. Cl. CPC B25B 27/143

(57) ABSTRACT

An installation tool, the use thereof, and a method for securing a threaded insert are being provided. The installation tool has a spindle, which is at least partly provided with a first outer thread and at least partly with a second thread, and a sleeve, which has a thread that meshes with the second thread. The length of the spindle and the length of the sleeve are adapted to each other such that the first outer thread protrudes at least partly out of the sleeve. The housing sleeve can be moved axially relative to the spindle by means of the thread engagement with the spindle, wherein the end position of said axial movement is defined by an axial stop of the spindle on the thrust bearing and/or rotational stop of the spindle on the housing sleeve.

### TECHNICAL AREA

The disclosure relates to an installation tool for threaded inserts, the use of such an installation tool with a threaded insert adapted thereto, and a method for securing a threaded insert in a workpiece.

### BACKGROUND

Threaded inserts, which can be designed as a threaded bushing or a threaded armoring, for example, are used in workpieces with lower mechanical load-bearing capacity, e.g., in components made of aluminum or gray cast iron, in order to be able to apply comparatively higher loads via the thread. Such threaded inserts are also suitable as repair solutions for damaged threads.

Threaded inserts are usually components that have an outer thread with which they are screwed into a possibly damaged thread of a component. The threaded inserts then also have an inner thread or a pin with an outer thread for connection to another component. Wedges or pins are driven into the threaded insert and/or the workpiece holding the threaded insert in order to securely fix threaded inserts in the possibly damaged thread or in a possibly softer material. In particular, this prevents the threaded insert from twisting in this workpiece.

In EP 3 205 454 B1, an installation tool for threaded inserts is proposed which has a spindle with a first outer thread and a second thread, a housing sleeve which has a thread engaging with the second thread, and locking means for releasably inhibiting rotation of the spindle relative to the housing sleeve. The spindle and the housing sleeve can be turned together in the first step of the installation of the threaded insert. For this purpose, locking means are provided which impede relative rotation between the spindle and housing sleeve at least to such an extent that no relative movement occurs between the housing sleeve and spindle at the comparatively low torque required to screw the threaded insert into the workpiece. If, on the other hand, a higher torque required for driving in the pins or wedges is applied, a relative movement between the housing sleeve and the spindle is permitted, wherein the relative axial movement component caused by the thread engagement between the housing sleeve and the spindle is used to drive in the pins or wedges.

In this known installation tool, the locking means which inhibit or impede relative rotation between the spindle and the housing sleeve are abutting stop surfaces of the spindle and the housing sleeve which, together with the intermeshing threads of the spindle and the housing sleeve, cause the spindle to be clamped in the housing sleeve. Due to the high friction between the stop surfaces, this jamming can prevent the housing sleeve from moving downwards relative to the spindle as required to drive in the pins or wedges. If a higher torque is applied, this can lead to damage to the surface and the threaded insert. In addition, the jamming can be further increased so that the tool can only be released by force if necessary.

### SUMMARY

In some non-limiting embodiments, the present disclosure provides, among other things, an improved installation tool for inserting a threaded insert into a workpiece (e.g., as recited in claim 1) that minimizes the risk of undesirably tight gripping. Further non-limiting embodiments relate to the use of such an improved installation tool with a threaded insert adapted thereto (e.g., as recited in claim 13) and an improved method of securing a threaded insert in a workpiece (e.g., as recited in claim 14).

A non-limiting embodiment of the disclosure is based on the idea that the risk of undesirably strong jamming between the spindle and the housing sleeve can be significantly minimized by reducing the underhead friction as much as possible.

In a non-limiting embodiment, an installation tool according to the disclosure has for this purpose a spindle which is provided at least partly with a first outer thread and at least partly with a second outer thread, the diameter of which is greater than the diameter of the first outer thread, and a housing sleeve which has a thread engaging with the second thread. For example, the diameter of the second outer thread is also larger than the diameter of the threaded insert that is to be secured in a workpiece with the installation tool. Here, for example, the length of the spindle and the length of the housing sleeve are adapted to each other in such a way that the first outer thread protrudes at least partially out of the housing sleeve. A thrust bearing is also axially fixed in the housing sleeve, which can, for example, rotatably support a thrust piece in the housing sleeve. The housing sleeve can be moved axially relative to the spindle due to the thread engagement with the spindle. An end position of this axial movement is defined by an axial stop of the spindle on the thrust bearing and/or a rotational stop of the spindle on the housing sleeve.

The different diameters of the two outer threads of the spindle mean that the resistance torque generated by thread friction in the thread engagement between the second outer thread of the spindle and the inner thread of the housing sleeve is greater than the resistance torque between the first outer thread of the spindle and an inner thread of the threaded insert. This means that the threaded insert can be screwed onto the spindle by turning it relative to the housing sleeve without the spindle turning in the housing sleeve. Even when screwing the threaded insert into the workpiece, the larger diameter of the second outer thread means that the resistance torque is lower than the resistance torque generated by thread friction in the thread engagement between the second outer thread of the spindle and the inner thread of the housing sleeve. Consequently, the spindle does not rotate in the housing sleeve when an installation torque acts on it. This effect can be further enhanced in non-limiting embodiments of the disclosure by the use of thread friction influencing measures. Thus, due to the increased thread friction in the thread engagement between the second outer thread of the spindle and the inner thread of the housing sleeve, a relative movement between the spindle and the housing sleeve is detachably inhibited in the end position between the spindle and the housing sleeve.

On the other hand, the reaction torque that occurs when the spindle itself or a component connected to it in a non-rotatable manner, for example a spacer ring or an adjustment ring, strikes the workpiece axially while the threaded insert is being screwed into a workpiece is considerably greater (theoretically even infinitely greater) than the resistance torque generated by thread friction in the thread engagement between the second outer thread of the spindle and the inner thread of the housing sleeve. Consequently, this stop of the spindle or a component connected to it in a rotationally fixed manner on the workpiece starts a relative rotation of the spindle in the housing sleeve as the installation torque continues to act on the housing sleeve. In other words, this releases the restraint of the relative movement between the spindle and the housing sleeve. The resulting axial relative movement between the housing sleeve and the spindle can be used to drive in the pins or wedges.

The direct seating of the spindle on the bearing or the seating of the spindle on one or more sliding washers, which in turn are supported directly on the bearing, facilitates the release of the restraint between the spindle and the housing sleeve, as the thrust bearing enables relative rotation without major friction.

Alternatively or additionally, jamming that is too tight can be achieved by limiting the rotary movement, for example by at least one rotary stop or by a pin.

The end position of the axial movement of the spindle relative to the housing sleeve, which is defined by the direct or indirect axial stop of the spindle on the thrust bearing and/or by the rotational stop of the spindle on the housing sleeve, is the position that the housing sleeve assumes relative to the spindle, while the relative rotation between the spindle and the housing sleeve is impeded or inhibited at least to such an extent that no relative movement occurs between the housing sleeve and the spindle at the comparatively low torque required to screw the threaded insert into the workpiece. If, on the other hand, a higher torque required for driving in the pins or wedges is applied, a relative movement between the housing sleeve and the spindle is permitted and the housing sleeve and the spindle move away from the end position. The relative axial movement component caused by the thread engagement between the housing sleeve and the spindle is used to drive in the pins or wedges.

In non-limiting embodiments of the installation tool, the spindle may have a first portion on which the first outer thread is provided, a second portion on which the second outer thread is provided, and a third portion connecting the first portion and the second portion, wherein the outer diameter of the second portion is larger than that of the third portion. The transition from the second section to the third section can define an axial stop surface of the spindle, which bears directly or indirectly against the thrust bearing in the end position.

The thrust bearing can, for example, be a needle bearing or a roller bearing in which the needles or rollers are arranged in a plane perpendicular to the longitudinal axis of the spindle, i.e., its axis of rotation. Alternatively, the thrust bearing can also be designed as a ball bearing, for example.

If the end position of the axial movement between the housing sleeve and the spindle is defined by an indirect axial stop of the spindle on the thrust bearing, at least one sliding washer can be provided between the spindle and the thrust bearing. Two sliding disks can be provided, each arranged in a plane perpendicular to the longitudinal axis of the spindle, i.e., to its axis of rotation.

The housing sleeve can have a first cylindrical section, in which the thread designed as an inner thread is provided, and a second cylindrical section, which is spaced from the first section by a web or flange projecting radially inwards. If the spindle has at least one first rotational stop, the radially inwardly projecting web or flange can have at least one counter-rotational stop complementary to the first rotational stop, which together define the end position of the axial movement between the housing sleeve and the spindle as a rotational stop.

In non-limiting embodiments of the installation tool, the screwing of the threaded insert into a workpiece and the subsequent driving in of the pins or wedges of the threaded insert is effected by rotation of the installation tool. This makes it possible to carry out the installation steps, namely screwing in the insert and driving in the pins or wedges, which previously had to be carried out separately, for example by continuously rotating the installation tool. This means that installation can be carried out using a cordless screwdriver or the like without the need for additional tools. Particularly in large-scale production, dispensing with a tool change saves a great deal of time and therefore increases efficiency. It is also possible to automate the installation of a threaded insert. Another advantage is that the pins or wedges are not driven in abruptly, so that damage to the pins or wedges can be largely ruled out.

For this purpose, according to a non-limiting embodiment of the disclosure, it is provided that the spindle and the housing sleeve can be rotated together in a first step of the installation of the threaded insert. For this purpose, the threads are designed with regard to their diameter and possibly other parameters influencing the resistance torque in such a way that relative rotation between the spindle and housing sleeve is at least made difficult to the extent that no relative movement occurs between the housing sleeve and spindle at the comparatively low torque required to screw the threaded insert into the workpiece. If, on the other hand, a higher torque required for driving in the pins or wedges is applied, a relative movement between the housing sleeve and the spindle is permitted, wherein the relative axial movement component caused by the thread engagement between the housing sleeve and the spindle is used to drive in the pins or wedges. In other words, when the threaded insert is screwed into the workpiece, the torque applied by the thread friction is greater than the reaction torque in the thread when the threaded insert is screwed in. When driving in the pins, on the other hand, the torque applied by the thread friction is less than the reaction torque of a spacer ring seated on the workpiece surface.

In any case, the spindle has a thread in two sections, namely the first outer thread for connection to the threaded insert on the one hand and a further thread that engages with the housing sleeve on the other. For example, the second thread can also be an outer thread that engages in an inner thread of the housing sleeve. The two threads can be designed as separate thread sections. Alternatively, a continuous thread can be provided on the spindle, which forms both threaded sections. Overlapping thread sections can also be provided on the spindle. For example, both thread sections can have the same direction of rotation. The thread sections can have the same or different pitches.

To avoid damage, the housing sleeve, which rotates both during the screwing of the threaded insert into the workpiece and during the driving in of the pins or wedges, can be provided in such a way that it does not rest directly against the pins or wedges that do not rotate. For this purpose, the side of the housing sleeve facing the insert can be provided with a friction-reducing coating. For example, a thrust piece arranged radially outside the spindle is mounted on or in the housing sleeve and has an end wall on the side facing away from the housing sleeve. The pins or wedges can be driven in with this end wall when the housing sleeve moves together with the thrust piece relative to the spindle. In order not to hinder the screwing of the spindle into the threaded insert, the length of the thrust piece, the length of the spindle, and the length of the housing sleeve are preferably adapted to each other in such a way that the first outer thread of the spindle protrudes at least partially out of the housing sleeve and from the thrust piece. For example, the thrust piece is freely rotatable relative to the housing sleeve and is not axially displaceable relative to the housing sleeve and is mounted on or in the housing sleeve. This can be done, for example, by using a needle or ball bearing and, if necessary, a circlip.

In order to automatically switch between the two operating modes of the installation tool, namely screwing in the insert by means of joint rotation of the housing sleeve and spindle and driving in the pins or wedges by means of rotation of the housing sleeve relative to the spindle, the spindle can be coupled non-rotatably to a spacer ring surrounding it at least partly, wherein the spacer ring for driving in the pins or wedges can be moved axially together with the spindle relative to the housing sleeve. The spacer ring is moved towards the workpiece together with the other components of the installation tool and together with the threaded insert while the threaded insert is being screwed into the workpiece. As soon as the face of the spacer ring facing away from the housing sleeve hits the workpiece surface, the torque required to rotate the installation tool increases. This increase in torque causes the restraint between the housing sleeve and spindle caused by thread friction, among other things, to be released, i.e., the frictional forces between the housing sleeve and spindle are exceeded, for example, as a result of which the housing sleeve is rotated relative to the spindle, which is fixed together with the spacer ring, if the housing sleeve continues to rotate. Due to the thread engagement, this causes the required relative axial movement between the spindle and the housing sleeve or thrust piece in order to move the pins or wedges relative to the threaded insert. The spacer ring can also be moved axially relative to the thrust piece. For this purpose, the spacer ring can be secured in the spindle by means of a pin, wherein elongated holes are provided in the thrust piece in which the pin is guided.

The use of the spacer ring makes it possible to determine the screw-in depth of the threaded insert in the workpiece very precisely, as the screw-in of the threaded insert is interrupted when the spacer ring hits the workpiece surface (end of the first operating mode) and the threaded insert is subsequently fixed in its position relative to the workpiece by driving in the wedges or pins. This makes it possible to install a large number of threaded inserts with high precision to a defined screw-in depth in the workpiece.

If different screw-in depths are to be realized, the spacer ring can be designed to be interchangeable, wherein different screw-in depths can be represented with different dimensions of the spacer ring. Alternatively, it is also possible to make the spacer ring adjustable. For this purpose, the spacer ring can have a multi-part design and, for example, have an outer thread that engages with the inner thread of an adjustment ring that surrounds the spindle at least partly. If necessary, the adjustment ring can be fixed in position with a lock nut, which also engages with the outer thread of the spacer ring. In this case, the position of the adjustment ring relative to the spacer ring and thus to the spindle defines the screw-in depth of the threaded insert or the switching between the operating modes of the installation tool. For a smaller screw-in depth of the threaded insert, the adjustment ring must be advanced further relative to the spindle in the screw-in direction of the threaded insert, so that the screw-in process is interrupted earlier, whereas the adjustment ring must be retracted relative to the spindle if a greater screw-in depth is to be achieved.

In a further non-limiting embodiment of the installation tool, the housing sleeve can have a first cylindrical section in which the thread designed as an inner thread is provided, and a second cylindrical section which is spaced from the first section by a radially inwardly projecting web or flange, and in which a flange section of the thrust piece is rotatably mounted and secured against axial movement. The spindle can have a shank at one end of which the first outer thread is provided and at the opposite second end of which the second thread, which is designed as an outer thread, is provided, wherein the second end can have an enlarged diameter compared to the shank. The thrust piece can, for example, grip around the shaft of the spindle and have two elongated holes in which the spacer ring is guided in a rotationally fixed and axially movable manner by means of a pin. The housing sleeve and optionally also the spindle can be equipped with engagement means for a torque-transmitting tool. Furthermore, the end wall on the side of the thrust piece facing away from the housing sleeve can be provided with a phase so that the thrust piece can be adapted to the geometry of the opening in the workpiece. Alternatively or additionally, a shoulder can also be provided on the end wall of the thrust piece.

A further aspect of a non-limiting embodiment relates to the use of an installation tool of the above-mentioned type for securing a threaded insert adapted to the installation tool. According to a further non-limiting embodiment, the threaded insert is designed as a sleeve with an outer thread and an inner thread, wherein at least one groove extending in the longitudinal direction is provided in the outer surface of the threaded insert, in which a wedge or pin is accommodated. The inner thread of the threaded insert is adapted to the first outer thread of the spindle of the installation tool so that they can be screwed into each other. In addition, the radial position of the at least one pin or wedge can be adapted to the radial position of the end wall of the thrust piece of the installation tool, so that the thrust piece can drive in the at least one pin or wedge.

Another aspect of a non-limiting embodiment relates to a method for securing a threaded insert in an opening of a workpiece. According to a non-limiting embodiment of such a method, an installation tool of the above-mentioned type is first provided, as well as a threaded insert adapted to the installation tool. The threaded insert is designed, for example, as a sleeve with an outer thread and an inner thread, wherein at least one groove running in the longitudinal direction is formed in the outer surface of the threaded insert, in which a pin or wedge is accommodated in such a way that the pin or wedge does not extend completely along the outer thread of the threaded insert in the axial direction. In other words, the pin or wedge does not initially block the outer thread of the threaded insert from being screwed into the workpiece, but protrudes beyond the sleeve-like base body of the insert on the side facing away from the workpiece. According to a non-limiting embodiment of the method, the threaded insert is then screwed onto the first outer thread of the spindle, wherein the rotation of the spindle relative to the housing sleeve is preferably already inhibited or locked for this purpose. The threaded insert is then screwed into the opening of the workpiece by rotating the housing sleeve together with the spindle until the spacer ring or any adjustment ring provided meets the workpiece with its end face facing away from the housing sleeve. The restraint between the housing sleeve and the spindle is either released automatically as described above or this can be achieved by a defined intervention, e.g., by releasing a locking element or switching a ratchet or rod. The threaded insert is then anchored in the opening of the workpiece by driving the pin or key into the groove and into the workpiece by rotating the housing sleeve relative to the spindle, the thrust piece, and the spacer ring. As described above, this causes an axial relative movement between the housing sleeve and the thrust piece on the one hand and the fixed spindle with the spacer ring on the other.

During the screwing of the threaded insert onto the first outer thread of the spindle and during the screwing of the threaded insert into the opening of the workpiece, the housing sleeve is in an end position relative to the spindle defined by an axial stop of the spindle on the thrust bearing and/or a rotational stop of the spindle on the housing sleeve. After releasing the restraint between the housing sleeve and the spindle, the housing sleeve can move away from the end stop relative to the spindle.

The housing sleeve is rotated, for example, using a motor-driven tool such as a drill, a cordless screwdriver, or a pneumatic screwdriver. Such tools can be equipped with an overload clutch, e.g., a slip clutch, which prevents the housing sleeve from being driven further when a maximum torque is reached. This can be used to ensure that the driving in of the pins or wedges is completed when the housing sleeve or the thrust piece has driven in the pins or wedges to such an extent that they are essentially flush with the sleeve-shaped base body of the insert, for example. When the housing sleeve or the thrust piece comes into contact with the sleeve-shaped base body of the insert, the torque required for further rotation of the housing sleeve increases abruptly. If the maximum torque that can be transmitted by the overload clutch is selected accordingly, this increase can be used to end the engagement process in a defined manner.

The installation tool can then be removed from the workpiece and the threaded insert. This is done by changing the rotational movement of the housing sleeve, which can initially cause another relative movement between the housing sleeve and spindle until the spindle is jammed against the housing sleeve again. Alternatively, this can also be achieved by actively actuating a locking element, ratchet, or rod. The housing sleeve and spindle can then be turned further together so that the spindle unscrews from the threaded insert. This returns the installation tool to its original position.

### BRIEF DESCRIPTION OF THE DRAWINGS

The features and advantages of the examples presented herein and the manner in which they may be achieved will become clearer and the examples better understood by reference to the following description in conjunction with the accompanying drawings, wherein:

FIG. 1 is an exploded view of the components of an installation tool according to the present disclosure,

FIG. 2 is a sectional view of the installation tool according to FIG. 1,

FIG. 3 is a perspective view of the installation tool according to FIG. 1,

FIG. 4 is a perspective view of the installation tool according to FIG. 1,

FIG. 5 is a side view of the installation tool according to FIG. 1,

FIGS. 6a through 6f are side views showing the steps in the installation of a threaded insert using the installation tool shown in FIG. 1,

FIGS. 7a, 7b is a sectional view of details of the steps involved in the installation of a threaded insert with the installation tool shown in FIG. 1,

FIG. 8 is a sectional view of an installation tool according to a second non-limiting embodiment of the present disclosure,

FIG. 9 is a sectional view of an installation tool according to a third non-limiting embodiment of the present disclosure, and

FIG. 10 is a sectional view of a detail of an installation tool according to a fourth non-limiting embodiment of the present disclosure.

### DETAILED DESCRIPTION

Various examples are described and illustrated here to provide a general understanding of the construction, function, and use of the disclosed securing collars, multi-part securing systems, and securing methods. The various examples described and illustrated here are neither restrictive nor exhaustive. Therefore, the invention is not limited by the description of the various non-limiting and non-exhaustive examples disclosed herein. Rather, the invention is defined exclusively by the claims. The features and properties shown and/or described in connection with various examples can be combined with the features and properties of other examples. Such modifications and variations should be included in the scope of this description. As such, the claims may be amended to recite any features or characteristics expressly or inherently described in this specification or otherwise expressly or inherently supported by this specification. Furthermore, the applicant reserves the right to amend the claims so as to expressly exclude features or properties which may be present in the prior art. The various embodiments disclosed and described herein may include, consist of, or consist essentially of the features and characteristics described herein.

Any reference to “various embodiments,” “some embodiments,” “one embodiment,” or similar expressions means that a particular feature, structure, or characteristic described in connection with the example is included in at least one embodiment. Therefore, the expressions “in various embodiments,” “in some embodiments,” “in one embodiment,” or similar expressions in the description do not necessarily refer to the same embodiment. Furthermore, the described features, structures, or properties may be combined in any suitable manner in one or more embodiments. Thus, the particular features, structures, or properties shown or described in connection with one embodiment may be combined, in whole or in part, with the features, structures, or properties of one or more other embodiments without limitation. Such modifications and variations are to be included in the scope of the present embodiments.

The term “between” means that the element in question is positioned between two other elements, but is not necessarily in contact with these other elements. Accordingly, an element that is “between” a first element and a second element may be adjacent to or in contact with the first and/or second element, and additional elements may be disposed between the intermediate element and the first and/or second element, unless otherwise indicated herein.

The figures show a non-limiting embodiment of the installation tool 1 according to the present disclosure. The installation tool 1 consists of a housing sleeve 2 and a spindle 3. Optionally, the installation tool 1 also has a thrust piece 4, a thrust bearing 5, a circlip 6, a spacer ring 7, a pin 8, and, if necessary, magnets 9.

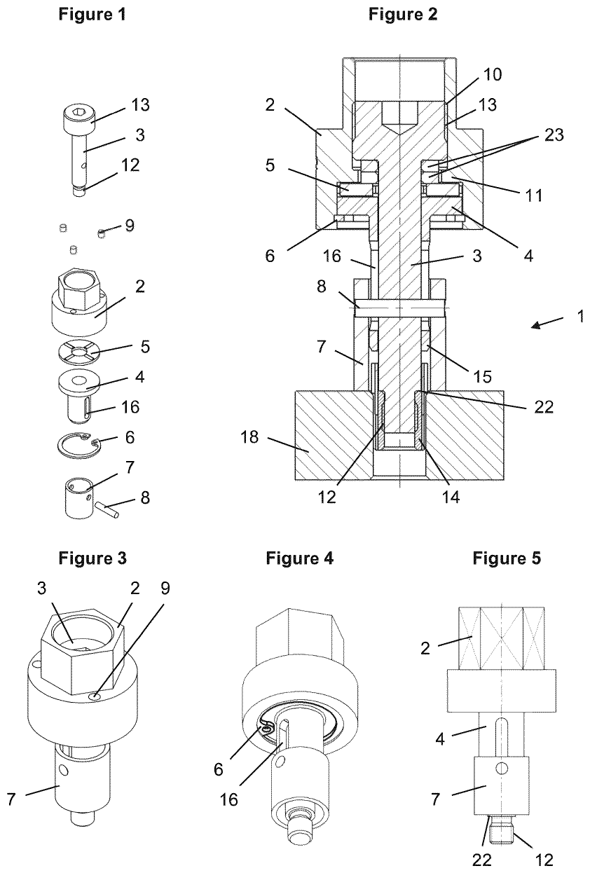

In the embodiment shown, the housing sleeve 2 is formed with a cylindrical section at the bottom in FIGS. 1 and 2, which forms a space for accommodating a region of the thrust piece 4, the bearing 5, and the circlip 6. In the embodiment shown in FIGS. 1 and 2, an upper section of the housing sleeve 2 is hexagonal on the outside, i.e., with an engagement means for a torque-transmitting tool, such as a wrench or a motor-driven screwdriver. The upper section of the housing sleeve 2 defines an essentially cylindrical space, which is provided with an inner thread 10. The upper chamber and the lower chamber of the housing sleeve 2 are spaced apart by a radially inwardly projecting flange 11, which has an opening for the spindle 3 to pass through. Three permanent magnets 9 are inserted in the lower section of the housing sleeve 2, which make it possible to hold the installation tool 1 magnetically to a torque-transmitting tool.

As in the embodiment shown, the spindle 3 can have a cylindrical shaft, for example, which connects two sections each provided with an outer thread. In the embodiment shown, a lower section of the spindle 3 in FIGS. 1 and 2 is designed with a smaller outer diameter than the shaft. This lower section has a first outer thread 12. An upper section of the spindle 3 in FIGS. 1 and 2 is designed with a head-like enlarged outer diameter and carries a second outer thread 13. In this upper area of the spindle 3, a further engagement means can be provided for a torque-transmitting tool, which is designed as an internal hexagon in the embodiment shown.

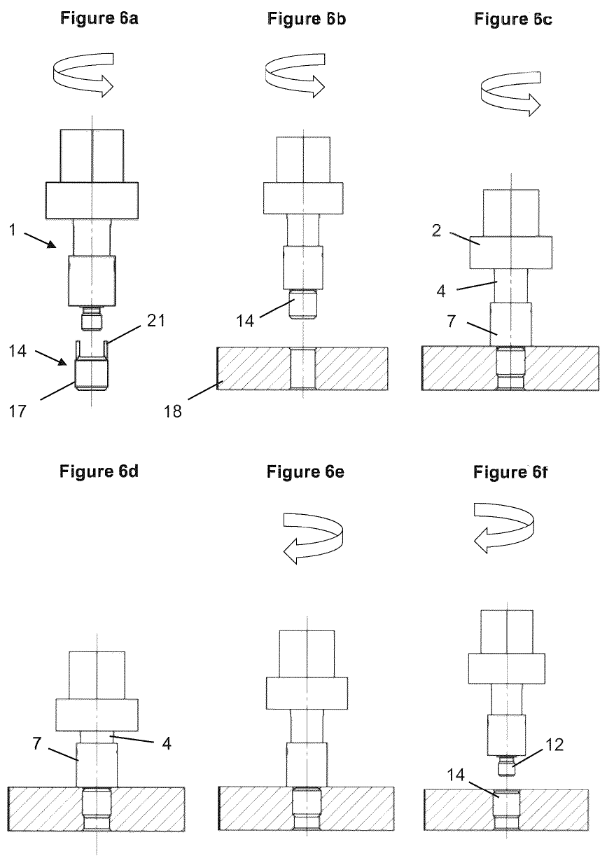

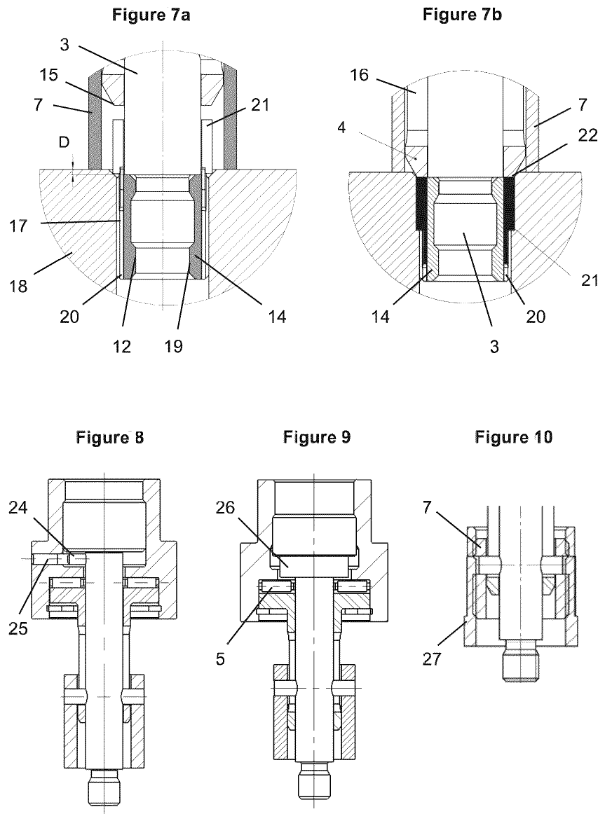

The first outer thread 12 of the spindle 3 can be screwed into a threaded insert 14, as described in more detail below, which is shown, for example, in FIGS. 6a and 7a. The second outer thread 13 of the spindle 3 engages in the inner thread 10 of the housing sleeve 2. In FIG. 2, the spindle 3 is screwed into the housing sleeve 2 so far that the shoulder between the shaft of the spindle 3 and the head of the spindle 3 carrying the second outer thread 13 rests against the thrust bearing 5 via two sliding washers 23, which also partially extend through the flange 11 of the housing sleeve 2. As an alternative to the design with two sliding washers 23 shown in FIG. 2, the shoulder between the shaft of the spindle 3 and the head of the spindle 3 carrying the second outer thread 13 can also bear directly against the thrust bearing 5.

This arrangement, in which the axial relative movement between the spindle 3 and the housing sleeve 2 is limited in one direction by the direct or indirect contact of the spindle 3 with the thrust bearing 5, defines an end position which the installation tool assumes during the screwing of the threaded insert 14 into a workpiece 18 and possibly also during the screwing of the threaded insert 14 onto the thread 12. In this end position of the spindle 3 in the housing sleeve 2, the spindle 3 and the housing sleeve 2 are clamped together, similar to a tightly tightened nut on a threaded bolt. In other words, the housing sleeve 2 can only be rotated relative to the spindle 3 when a torque that overcomes this clamping is exceeded. Due to the contact with the thrust bearing 5, however, this tension can be released without fear of damaging the threaded connection between the spindle 3 and the housing sleeve 2. The engagement of the second outer thread 13 in the inner thread 12 causes a relative axial movement to occur when the housing sleeve 2 rotates relative to the spindle 3, as a result of which the spindle 3 moves upwards relative to the housing sleeve 2 in FIGS. 1 and 2.

In the embodiment shown, the thrust piece 4 is a sleeve-like component with a flange-like end at the top in FIGS. 1 and 2. The thrust piece 4 grips the shaft of the spindle 3 in such a way that the spindle 3 can be moved in an axial direction relative to the thrust piece 4. The thrust piece 4 is rotatably mounted with its flange-like end in the lower area of the housing sleeve 2. For this purpose, bearing 5 is provided between the housing sleeve 2 and the thrust piece 4, which is designed as a nail bearing in the embodiment shown. The thrust piece 4 is held in the housing sleeve 2 by means of the circlip 6 in such a way that the thrust piece 4 does not move axially relative to the housing sleeve 2. At its end facing away from the housing sleeve 2 (bottom in FIGS. 1 and 2), the thrust piece 4 is provided with an end wall 15, which can be stepped, for example, or provided with a phase, as in the embodiment shown. Furthermore, as in the embodiment shown, the thrust piece 4 can be provided with two opposing elongated holes 16, which extend in the longitudinal direction of the installation tool 1.

The spacer ring 7 is also designed as an essentially sleeve-shaped component. The spacer ring 7 has an inner diameter that is slightly larger than the outer diameter of the thrust piece 4, so that the spacer ring 7 surrounds the thrust piece 4 but can be moved relative to it. The pin 8 secures the spacer ring 7 to the thrust piece 4 and to the spindle 3 by engaging through the lateral openings of the spacer ring 7, the elongated holes 16 of the thrust piece 4, and a transverse opening in the shaft of the spindle 3. In this way, the spacer ring 7 is connected to the spindle 3 so that it cannot rotate or move axially. In addition, the spacer ring 7 is connected to the thrust piece 4 in a rotationally fixed but axially displaceable manner.

As can best be seen from FIG. 7a, the threaded insert 14 is also sleeve-shaped and has an outer thread 17 for screwing into a threaded opening of a workpiece 18. Furthermore, the threaded insert 14 is provided with an inner thread 19, which is adapted to the first outer thread 12 of the spindle 3. Furthermore, grooves 20 are formed in the outer surface of the threaded insert 14, which run in an axial direction, i.e., in the longitudinal direction of the installation tool. A pin or wedge 21 is inserted into each groove 20, which is held in the groove 20 by clamping force. If necessary, the wedge 21 can also be detachably connected to the threaded insert 14 in another way.

Before the installation of the threaded insert 14, the wedges 21 initially protrude beyond the base body of the threaded insert 14 in the screw-in direction, i.e., on the side facing away from the workpiece 18, as shown in FIGS. 6a and 7a. This means that the wedges 21 do not overlap the outer thread 17 of the threaded insert 14, or at most only to a small extent, so that the wedges 21 do not hinder the screwing of the threaded insert 14 into the workpiece 18. In principle, a single wedge 21 is sufficient to fix the threaded insert 14 in the workpiece 18. However, as shown in the illustrated embodiment, at least two wedges 21 can be provided on the threaded insert 14.

In the following, the installation of a threaded insert 14 by means of the installation tool 1 in a workpiece 18 is described in more detail with reference to FIGS. 2 and 6a through 7b:

At the beginning of the installation process, the housing sleeve 2 and the spindle 3 are in the end position shown in FIG. 2 relative to each other, i.e., the spindle 3 is screwed into the housing sleeve 2 up to the flange 11 and clamped there in such a way that a low torque can be transmitted from the housing sleeve 2 to the spindle 3 without them moving relative to each other. This position is also referred to below as the first operating mode. Alternatively or additionally, this first operating mode can also be achieved by providing a rotational stop between the housing sleeve 2 and the spindle 3.

As can be seen in FIGS. 2 and 6a, in this state the first outer thread 12 of the spindle 3 protrudes beyond the end wall of the spacer ring 7 facing the workpiece 18 (bottom in FIG. 2). The threaded insert 14 can thus be connected to the installation tool 1 by rotating the housing sleeve 2, whereby the spindle 3 is also rotated and its first outer thread 12 is screwed into the inner thread 19 of the threaded insert 14. The wedges 21 protrude into the ring-like free space between the spacer ring 7 and the shaft of the spindle 3. A shoulder 22 is formed at the transition between the shank of the spindle 3 and the first outer thread 12, against which the sleeve-like base body of the threaded insert 14 abuts when the threaded insert 14 is fully screwed onto the spindle 3. This can be seen in FIGS. 7a and 7b.

The threaded insert 14 can then be guided together with the installation tool 1 to the workpiece 18 provided with a threaded opening, wherein the threaded insert 14 is screwed into the workpiece 18, in which the housing sleeve 2 is further rotated. The torque required for this is comparatively low, so that the clamping connection between the housing sleeve 2 and the spindle 3 does not loosen, but the torque is transmitted via the housing sleeve 2 into the spindle 3 and into the threaded insert 14. This is shown in FIGS. 6b and 6c.

The screw-in depth D of the threaded insert 14 in the workpiece 18 can be defined, for example, by the axial extension of the spacer ring 7. As can be seen from FIG. 7a, the axial distance D between the side of the shoulder 22 facing the workpiece 18 and the end face of the spacer ring 7 facing the workpiece 18 determines the screw-in depth of the threaded insert 14 into the workpiece 18. It strikes the face of the spacer ring 7 on the surface of the workpiece 18 when the threaded insert 14 is fully screwed into the workpiece 18.

If the distance D between the shoulder 22 of the spindle 3 and the face of the spacer ring 7 is chosen to be greater, i.e., if the spacer ring 7 is smaller than in the embodiment shown, the threaded insert 14 can be screwed deeper into the workpiece 18. Conversely, the threaded insert 14 is flush with the workpiece surface when the shoulder 22 of the spindle 3 is flush with the face of the spacer ring 7 or the threaded insert 14 protrudes beyond the workpiece surface 18 when the shoulder 22 of the spindle 3 is set back from the face of the spacer ring 7. The screw-in depth of the threaded insert 14 can be adapted to different requirements using spacer rings 7 of different lengths.

Alternatively, the screw-in depth of the threaded insert 14 can also be limited by the wedges 21 hitting the workpiece 18. FIG. 7a shows how one edge of the wedges 21 strikes against a phase of the opening in the workpiece 18 when the end face of the spacer ring 7 touches the surface of the workpiece 18.

The contact between the face of the spacer ring 7 with the surface of the workpiece 18 or the contact of the wedges 21 with the workpiece 18 causes the torque required for screwing in the threaded insert 14 to increase abruptly when the rotation causes the spindle 3 with the threaded insert 14 to penetrate further into the workpiece 18 and at the same time the spacer ring 7, which is axially connected to the spindle 3 via the pin 8, is pressed against the surface of the workpiece 18. This increase in torque causes the clamping connection between the housing sleeve 2 and the spindle 3 to loosen. As the spindle 3 is in direct or indirect contact with the thrust bearing 5, the clamp connection can be easily released. A similar effect is achieved if the tension between the housing sleeve 2 and the spindle 3 is limited by a rotational stop (not shown), which limits the relative rotation between these components, so that the tension does not become too great.

This process transfers the installation tool 1 to its second operating mode, in which the housing sleeve 2 and the spindle 3 can be rotated relative to each other. Spindle 3 and housing sleeve 2 move away from the end position shown in FIG. 2 by relative movement.

As shown in FIGS. 6d and 7b, continued rotation of the housing sleeve 2 in the second operating mode causes a relative axial movement between the housing sleeve 2 and the spindle 3. The spacer ring 7 is axially fixed to the spindle 3 and remains in the position shown in FIG. 7a. The relative movement between the housing sleeve 2 and the spindle 3 also moves the thrust piece 4 relative to the spindle 3 (downwards in FIG. 2). This movement causes the end wall 15 of the thrust piece 4 to hit the side of the wedges 21 facing the installation tool 1 (top in FIGS. 7a and 7b) and drives this further into the grooves 20 and into the workpiece 18 as the housing sleeve 2 continues to rotate. This anchors the threaded insert 14 securely in the workpiece 18. This state is shown in FIG. 7b.

As soon as the end wall 15 of the thrust piece 4 or the phase attached to it comes into contact with the workpiece 18, the torque increases significantly again. This second increase in torque can be used to switch off a tool driving the installation tool 1, for example by means of a slip clutch.

The installation tool 1 can now be returned to its first operating mode and unscrewed from the workpiece 18 and the threaded insert 14. For this purpose, the direction of rotation of the tool driving the housing sleeve is reversed, as shown in FIGS. 6e and 6f. Since the spindle 3 and the spacer ring 7 are at least slightly braced with the workpiece 18 above the threaded insert 14, a relative movement between the housing sleeve 2 and the spindle 3 first occurs again when the direction of rotation of the housing sleeve is reversed, until the spindle 3 has reached the end position shown in FIG. 2. When the spindle 3 stops against the flange 11 of the housing sleeve 2, it jams against the latter again, so that the spindle 3 and the housing sleeve 2 are in their first operating mode, which is connected to each other in a rotationally fixed manner. Alternatively or additionally, this can be done via a manually or automatically intervening locking device. As the housing sleeve 2 continues to rotate, the first outer thread 12 of the spindle 3 is then unscrewed from the threaded insert 14, completing the installation process.

A second embodiment is shown in FIG. 8. The design of the installation tool 1 is essentially the same as the previously described embodiment. Identical components are therefore designated with the same reference numbers. The installation tool 1 has a pin 24 that protrudes radially from the spindle 3 and is fixed in it. In other words, the pin 24 moves together with the spindle 3 when it is moved. In the state shown in FIG. 8, which defines an end position of the spindle 3 relative to the housing sleeve 2, the pin 24 is in axial contact with the flange 11. With relative rotation, this line contact causes less friction than full-surface contact of the spindle 3 with the flange 11. This alone can effectively prevent unwanted jamming.

FIG. 8 also shows a second pin 25, which projects radially inwards in the housing sleeve 2, namely into the first cylindrical section of the housing sleeve 2. In the end position shown in FIG. 8, the pins 24 and 25 strike against each other in the direction of rotation and thus form a rotational stop between the spindle 3 and the housing sleeve 2. This also prevents the spindle 3 from jamming in the housing sleeve 2.

A third embodiment is shown in FIG. 9. The design of the installation tool 1 is essentially the same as that of the previously described embodiments. Identical components are therefore designated with the same reference numbers. The installation tool 1 has a shoulder 26 on the lower side of the head section of the spindle 3 shown in the figure, which rests against the thrust bearing 5 in the end position shown. This shoulder 26 thus replaces the sliding washers 23 shown in FIG. 2, so that the spindle makes direct contact with the thrust bearing 5. In contrast to the illustration shown in FIG. 9, the diameter of the shoulder 26 does not have to be significantly smaller than the head section with the outer thread 13. However, this shoulder 26 must not impede the movement of the spindle 3 in the cylindrical section of the housing sleeve 2.

Another alternative embodiment is shown in FIG. 10. The design of the installation tool 1 is essentially the same as that of the previously described embodiments. Identical components are therefore designated with the same reference numbers. The difference between the first embodiment and the embodiment according to FIG. 10 is that an outer thread is provided on the spacer ring 7 according to FIG. 10. An adjustment ring 27 is screwed onto this outer thread with an inner thread. A lock nut is also provided, which also engages with the outer thread. The adjustment ring 27 can be fixed in its position on the spacer ring 7 by means of the lock nut. When the lock nut is loosened, the position of the adjustment ring 27 can be changed relative to the spacer ring 7. In this way, the distance between the end face of the adjustment ring 27 facing the workpiece 18 and the shoulder 22 of the spindle 3 is also changed at the same time. This allows the screw-in depth of a threaded insert 14 in a workpiece 18 to be adapted without replacing the spacer ring 7 by setting the position of the adjustment ring 27 accordingly.

In this description, unless otherwise specified, all numerical parameters shall be understood to be preceded and modified by the term “approximately”, wherein the numerical parameters have the inherent variability characteristic of the underlying measurement techniques used to determine the numerical value of the parameter. At a minimum, and not as an attempt to limit the application of the doctrine of equivalents to the scope of the claims, each numerical parameter described herein should be construed in light of the number of significant digits disclosed and using ordinary rounding methods.

In addition, each numerical range listed here includes all sub-ranges that fall under the specified range. For example, a range of “1 to 10” includes all sub-ranges between (and including) the specified minimum value of 1 and the specified maximum value of 10, i.e., with a minimum value equal to or greater than 1 and a maximum value equal to or less than 10. Any numerical maximum limit stated in this specification shall include any lower numerical limits subsumed thereunder, and any numerical minimum limit stated in this specification shall include any higher numerical limits subsumed thereunder. Accordingly, the applicant reserves the right to amend this specification, including the claims, to expressly recite any sub-scope falling within the areas expressly recited. All these areas are included in this description.

The grammatical articles “one” and “the” as used herein shall, unless otherwise indicated, include “at least one” or “one or more”, even if “at least one” or “one or more” is used explicitly in certain cases. Therefore, the foregoing grammatical articles are used herein to refer to one or more than one (i.e., “at least one”) of the particular identified elements. Furthermore, the use of a noun in the singular also includes the plural, and the use of a noun in the plural includes the singular, unless the context of use requires otherwise.

The skilled person will recognize that the connecting elements, structures, processes/actions, and objects described herein and the accompanying discussions are used as examples for the sake of conceptual clarity and that various configuration changes are contemplated. Consequently, the specific examples/excerpts given here and the accompanying discussion are intended to be representative of their more general classes. In general, the use of a particular example is intended to be representative of its class, and the omission of specific components, devices, appliances, operations/actions, and objects should not be construed as limiting. While the present disclosure provides descriptions of various specific aspects to illustrate various aspects of the present disclosure and/or its potential applications, it is understood that those skilled in the art will make variations and modifications. Accordingly, the invention(s) described herein are to be construed at least as broadly as claimed and not as narrowly as defined by the particular illustrative aspects contained herein.

### Reference Sign

1 Installation tool 16 Elongated hole
2 Housing sleeve 17 Outer thread
3 Spindle 18 Workpiece
4 Thrust piece 19 Inner thread
5 Bearing 20 Slot
6 Circlip 21 Wedge
7 Spacer ring 22 Shoulder
8 Pin 23 Sliding washer
9 Magnet 24 Pin
10 Inner thread 25 Pin
11 Flange 26 Shoulder
12 First outer thread 27 Adjustment ring
13 Second outer thread
14 Threaded insert D Distance
15 Front wall

1. An installation tool for threaded inserts, the installation tool comprising:
a spindle which is provided at least partly with a first outer thread and at least partly with a second outer thread, wherein a diameter of the second outer thread is greater than a diameter of the first outer thread,
a housing sleeve comprising a sleeve thread engaging with the second outer thread, wherein a length of the spindle and a length of the housing sleeve are adapted to one another such that the first outer thread protrudes at least partially out of the housing sleeve, and
a thrust bearing is axially fixed in the housing sleeve,
wherein the housing sleeve is configured to be axially movable relative to the spindle by engagement of the sleeve thread with the second outer thread,
wherein an end position of axial movement of the housing sleeve is defined by one or both of:
an axial stop of the spindle on the thrust bearing; and
a rotational stop between the spindle and the housing sleeve.

2. The installation tool according to claim 1, wherein the spindle has a first section on which the first outer thread is provided, a second section on which the second outer thread is provided, and a third section connecting the first section and the second section, wherein an outside diameter of the second section is greater than an outside diameter of the third section, and a transition from the second section to the third section defines the axial stop of the spindle.

3. The installation tool according to claim 1, characterized in that the end position of the axial movement between the housing sleeve and the spindle is defined by a direct axial stop of the spindle on the thrust bearing.

4. The installation tool according to claim 1, characterized in that at least one sliding washer is provided between the spindle and the thrust bearing, so that the end position of the axial movement between the housing sleeve and the spindle is defined by an indirect axial stop of the spindle on the thrust bearing.

5. The installation tool according to claim 2, characterized in that the housing sleeve has a first cylindrical section in which the sleeve thread is formed as an inner thread, and has a second cylindrical section which is spaced from the first section by a radially inwardly projecting web or flange.

6. The installation tool according to claim 5, characterized in that the spindle has at least one first rotational stop and the housing sleeve has at least one counter-rotational stop complementary to the first rotational stop, wherein the at least one first rotational stop and the at least one counter-rotational stop together define the end position of the axial movement between the housing sleeve and the spindle as a rotational stop.

7. The installation tool according to claim 6, characterized in that the first rotational stop is formed by a first pin protruding radially out of the spindle, and/or in that the counter-rotational stop is formed by a second pin projecting radially into the first cylindrical section of the housing sleeve.

8. The installation tool according to claim 5, characterized in that a thrust piece arranged radially outside the spindle is provided on or in the housing sleeve, which thrust piece is mounted on or in the housing sleeve so as to be freely rotatable relative to the housing sleeve but not axially displaceable relative to the housing sleeve, wherein a length of the thrust piece, the length of the spindle, and the length of the housing sleeve are adapted to one another in such a way that the first outer thread protrudes at least partially out of the housing sleeve and out of the thrust piece, and wherein the thrust piece has an end wall on a side facing away from the housing sleeve.

9. The installation tool according to claim 8, characterized in that the spindle is coupled in a rotationally fixed manner to a spacer ring surrounding the spindle at least partly, wherein the spacer ring is axially movable together with the spindle relative to the housing sleeve and is axially movable relative to the thrust piece.

10. The installation tool according to claim 9, characterized in that the spacer ring has an outer thread which engages with the inner thread of an adjustment ring surrounding the spindle at least partly.

11. The installation tool according to claim 8, characterized in that a flange section of the thrust piece is rotatably mounted in the second cylindrical section of the housing sleeve by means of the thrust bearing and is secured against axial movement.

12. The installation tool according to claim 9, characterized in that the thrust piece engages around a shank of the spindle and has two elongated holes in which the spacer ring is guided in a rotationally fixed and axially movable manner by means of a pin.

13. A method comprising securing a threaded insert in an opening of a workpiece using the installation tool of claim 8, wherein the threaded insert is designed as a sleeve with an outer thread and an inner thread, wherein at least one groove extending in a longitudinal direction is formed in an outer surface of the threaded insert, in which groove a pin is accommodated, wherein the inner thread of the threaded insert is adapted to the first outer thread of the spindle and a radial position of the pin is adapted to a radial position of the end wall of the thrust piece.

14. A method for securing a threaded insert in an opening of a workpiece, the method comprising :
providing an installation tool according to claim 10 and a threaded insert adapted to the installation tool, wherein the threaded insert is designed as a sleeve with an outer thread and an inner thread, wherein at least one groove extending in a longitudinal direction is formed in an outer surface of the threaded insert, in which groove a pin is accommodated in such a way that the pin does not extend completely in an axial direction along the outer thread of the threaded insert;
screwing the threaded insert onto the first outer thread of the spindle while a rotation of the spindle relative to the housing sleeve is inhibited and the housing sleeve is located relative to the spindle in an end position defined by an axial stop of the spindle on the thrust bearing and/or a rotational stop of the spindle on the housing sleeve;
screwing the threaded insert into the opening of the workpiece by rotating the housing sleeve together with the spindle until the spacer ring or the adjustment ring meets the workpiece with its end face facing away from the housing sleeve;
releasing restraint between the housing sleeve and the spindle; and
anchoring the threaded insert in the opening of the workpiece by driving the pin into the groove and into the workpiece by means of a rotation of the housing sleeve relative to the spindle, the thrust piece, and the spacer ring, during which the housing sleeve moves away from an end stop relative to the spindle.
